(19) United States
(12) Patent Application Publication
(10) Pub. No.: US 2016/0048871 A1
(43) Pub. Date: Feb. 18, 2016

(54) TARGETED ADVERTISING SYSTEM AND METHOD FOR A RETAIL KIOSK

(71) Applicant: GIFT CARD IMPRESSIONS, LLC, Kansas City, MO (US)

(72) Inventors: Brett R. Glass, Kansas City, MO (US); Ryan Cain, Kansas City, MO (US); Karl Joseph Geisler, Kansas City, MO (US)

(21) Appl. No.: 14/828,948

(22) Filed: Aug. 18, 2015

Related U.S. Application Data
(60) Provisional application No. 62/038,683, filed on Aug. 18, 2014.

(51) Int. Cl. G06Q 30/02; G06Q 50/00

(52) U.S. Cl. CPC G06Q 30/0251; G06Q 50/01

(57) ABSTRACT

A retail kiosk advertising system includes a retail display structure management server in communication with one or more retail display structures that support and display a retailer computing device and one or more consumer items for sale. The retail display structure management server receives proximity information from a proximity sensing device configured on the retail display structure in which the proximity information indicates when a portable computing device is within a specified range of the retail display structure. In response, the server determines an identity of a user of the portable computing device, obtains targeted advertising content associated with the consumer items, transmits the targeted advertising content to the retailer computing device. The retailer computing device also plays the targeted advertising for view by the user, and facilitates a transaction for the consumer item with the user.

### RELATED APPLICATIONS

This application claims priority to provisional patent application No. 62/038,683, filed Aug. 18, 2014, which is entitled “Targeted Advertising System and Method For a Retail Kiosk.” The contents of No. 62/038,683 is hereby incorporated by reference in its entirety.

### FEDERALLY SPONSORED RESEARCH OR DEVELOPMENT

Not Applicable.

### COMPACT DISK APPENDIX

Not Applicable.

### FIELD OF INVENTION

The present invention generally relates to retail devices, and more particularly, to a targeted advertising system and method for a retail kiosk.

### BACKGROUND

Targeted advertising generally involves the use of various forms of information known about consumers to tailor advertisements directed to each of the consumers. The information may include that information known about a group of which the consumer may be a member (e.g., demographics, firmographics, etc.) or may be specific information known about each particular consumer, such as information obtained via one or more loyalty card programs, or one or more social media websites. In general, targeted advertising systems use behavioral traits associated with consumers to adjust or modify advertisements into a form that optimizes an appeal to a product or service promoted in the advertisements.

### SUMMARY

According to one aspect, a retail kiosk advertising system includes a retail display structure management server in communication with one or more retail display structures that support and display a retailer computing device and one or more consumer items for sale. The retail display structure management server receives proximity information from a proximity sensing device configured on the retail display structure in which the proximity information indicates when a portable computing device is within a specified range of the retail display structure. In response, the server determines an identity of a user of the portable computing device, obtains targeted advertising content associated with the consumer items, transmits the targeted advertising content to the retailer computing device. The retailer computing device also plays the targeted advertising for view by the user, and facilitates a transaction for the consumer item with the user.

### BRIEF DESCRIPTION OF THE DRAWINGS

FIG. 1A illustrates an example targeted advertising system for a retail kiosk according to the teachings of the present disclosure.

FIG. 1B is a block diagram of an example kiosk computing system according to the teachings of the present disclosure.

FIG. 1C depicts an example data source of the kiosk management server according to the teachings of the present disclosure.

FIG. 2 is an example kiosk management server that includes a kiosk management application according to the teachings of the present disclosure.

FIG. 3 is a flowchart depicting a process for generating targeted advertising content according to the teachings of the present disclosure.

### DETAILED DESCRIPTION

Although targeted advertising systems have provided an enhanced mechanism for marketing of goods or services, their use has not been without limitation. For example, since conventional targeted advertising systems typically require unique identification of consumers from which to derive targeted advertising content, their use has been relegated for use with communication infrastructures (e.g., the Internet, point of sale (POS) systems, and the like) that are capable of obtaining unique identification of consumers in real time. That is, targeted advertising is most beneficially applied when the unique identity of each consumer is readily obtained. In many cases, however, these communication infrastructures do not provide a platform for enabling targeted advertising where purchasing decisions are made, such as in an aisle of a retail store where consumer items are displayed for purchase, much less enabling a financial transaction for the consumer items with the consumer. Embodiments of the present disclosure provide a solution to these problems, among other problems, via a kiosk based targeted advertising system that generates targeted advertising for consumer items displayed at or near a kiosk or other retail display structure that also displays these consumer items and/or facilitates financial transactions for the consumer items with the consumer. In this manner, the targeted advertising may be applied in relatively close proximity to where purchase decisions are made using a system that facilitates financial transactions. Thus, the time required for conducting a financial transaction from when the targeted advertising is applied may be shortened for enhanced sales.

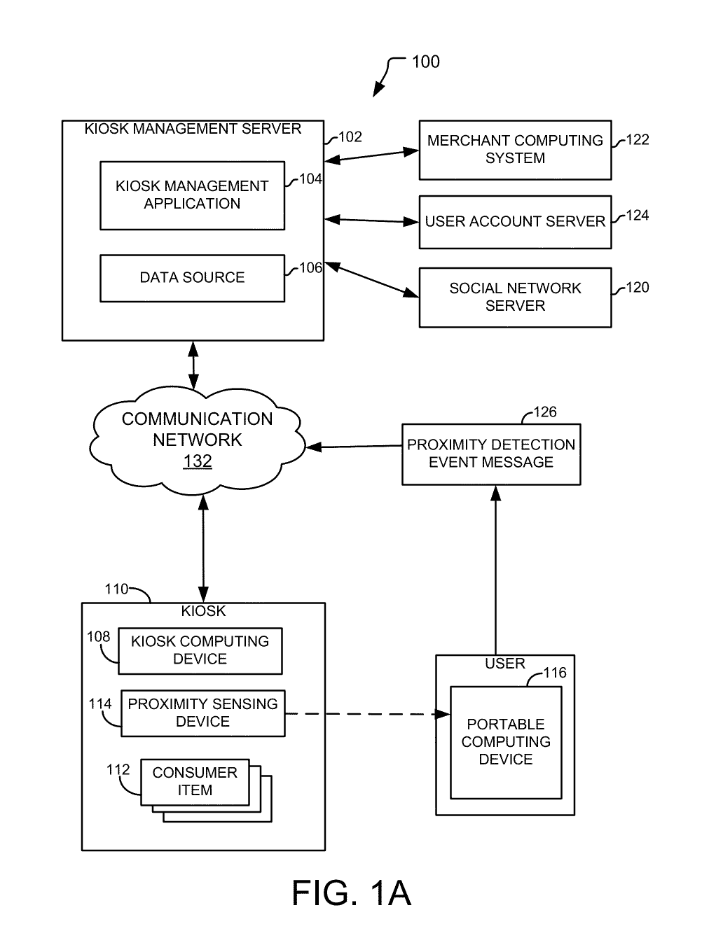

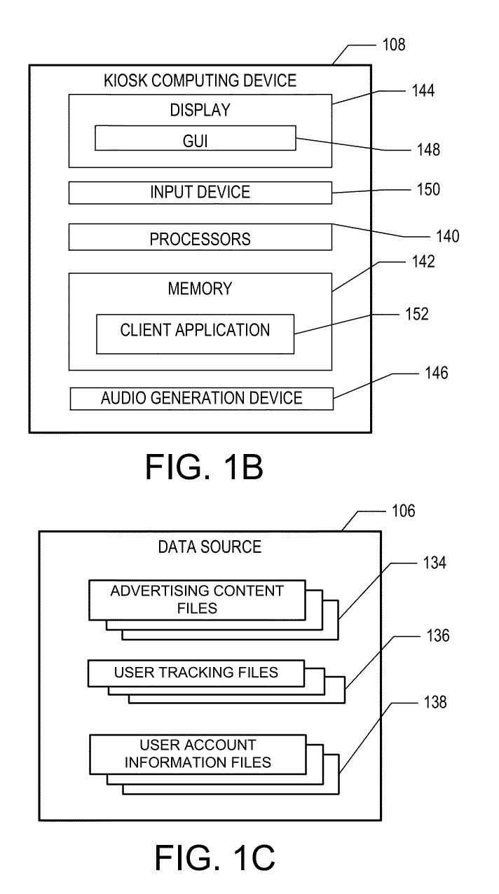

FIGS. 1A through 1C depict an example targeted advertising system for a retail kiosk 108 according to aspects of the disclosure. The system 100 includes a kiosk management server 102 or other computing device or system that includes a kiosk management application 104 and a data source 106. The kiosk management application 104 is in communication with a kiosk computing device 108 housed in a kiosk 110 for displaying advertising content associated with one or more consumer items 112 supported and displayed by the kiosk 110 as well as conducting financial transactions for the consumer items 112. As will be described in detail below, the kiosk 110 includes a proximity sensing device 114 that functions with a portable computing device 116 of a user to provide targeted advertising associated with the consumer items 112 for the user when the proximity sensing device 114 senses that the user is in relatively close proximity to the kiosk 110.

The targeted targeted advertising (e.g., marketing) content (e.g., advertisements, special offers, etc.) may be displayed on the display of the kiosk computing device 108 for view by the user. The targeted advertising content may be pushed to the kiosk computing device 108 from the kiosk management server 102 and played under control of the kiosk management application 104. For example, the kiosk management application 104 may selectively push targeted advertising content to be displayed based upon information known about the user, such as that obtained from one or more social network servers 120, such as those administered by FACEBOOK™ TWITTER™, PINTEREST™, or even information derived (e.g., data mined) by the application 104. The advertising content may be presented in any suitable form, such as a video segment, an animation, a text message, audio message, or any combination thereof. In some respects, the display of the kiosk computing device 108 may be considered to be a digital billboard in which advertising content is displayed to potential consumers in close proximity to where these consumers formulate decisions whether or not to purchase consumer items (e.g., stored value cards) advertised by the display of the kiosk computing device 108.

The consumer items may be any type that can be supported, and displayed by the kiosk 110. For example, the consumer items 112 may include stored value cards associated with a monetary amount to be redeemed for one or more products or services. Examples of such stored value cards include for example, gift cards, pre-paid phone service cards, general purpose credit cards, debit cards, and the like.

The server 102 also communicates with one or more merchant computing systems 122 administered by merchants that provide the consumer items 112 for sale. The server 102 may receive advertising content that is customized according to information known about the user from the merchant computing system 122 that is subsequently pushed down to the kiosk computing device 108. The server 102 may also communicate with one or more user account servers 124 that are associated with a corresponding one or more accounts of the user. For example, the server 102 may communicate with a financial account server associated with the user to conduct a financial transaction for payment of a consumer item 112. The financial account may include any type, such as a credit card account, a debit card account, a GOOGLE WALLET™ account, or a PAYPAL™ account of the user. As another example, the server 102 may communicate with a loyalty account of the user (e.g., a grocery store loyalty card account, a fuel points reward program, a prepaid phone account, etc.) to obtain information from which analytic information may be derived, to obtain analytic information previously derived by a separate analytics generating system using information in the account, and/or change one or more parameters of the account (e.g., increase/decrease maximum spending limits of a financial account).

The merchant computing system 122, the user account server 124, and the social network server 120 have one or more processors and executable instructions stored in volatile and/or non-volatile memory for performing the actions and/or steps described herein.

The proximity sensing device 114 may be any device that is used to determine a unique identity from which the targeted advertising may be generated. For example, the proximity sensing device 114 may form a portion of an indoor positioning system (IPS) that uses radio frequency (RF) signals, optical signals (e.g., infrared radiation), magnetic energy, and/or acoustic signals (e.g., ultrasonic energy) for detection of portable computing devices 116 that are each uniquely associated with a particular user. In one embodiment, the proximity sensing device 114 comprises an IPS, such as an IBEACON™ device, that generates a relatively weak RF signal that, when detected by the portable computing device 116, causes the portable computing device 116 generate a proximity detection event message 126 that is transmitted to the kiosk management server 102. The portable computing device 116 may transmit the proximity detection event message 126 to the server 102 via a circuit-switched telephone network (e.g., a public switched telephone network (PSTN), a cellular (i.e., wireless) telephone network), or via a packet-switched communication network, such as the Internet.

The data source 106 stores advertising content files 134, user tracking files 136, and user account information files 138. The advertising content files 134 includes advertising messages in the form of text messages, audio messages, image messages, and/or video messages that may be displayed on the display of the kiosk computing device 108. For example, multiple advertising content files 134 may include multiple advertising content files for a single consumer item 112 in which each content file is customized according to targeted information known about the user. The user tracking files 136 includes tracking information associated with the user. For example, the tracking information may include information associated various aspects about the user's behavior, such as where and when the user comes in close proximity to the kiosk 110 or other kiosks 108 managed by the system 100, and historical information associated with past purchases of consumer items 112 by that particular user. The user account files 138 stores information associated with one or more accounts of the user, such as a financial account that may be used for conducting a financial transaction for purchase of one of the consumer items, and/or a social media account that may be used to obtain analytic information associated with the user.

Although the data source 106 is shown as being located on, at, or within the local server 102, it is contemplated that the data source 106 can be located remotely from the local server 102 in other aspects of the system 100, such as on, at, or within a database of a data management system or a database of another computing device or system having at least one processor and volatile and/or non-volatile memory.

The communication network 132 can be the Internet, an intranet, a circuit-switched telephone network, such as a public switched telephone network (PSTN), a cellular (i.e., wireless) telephone network, or another wired and/or wireless communication network. In one aspect, one or more of the server 102 and the kiosk computing device 108 communicate with one another using any suitable protocol or messaging scheme. For example, the server 102 and kiosk computing device 108 may communicate using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 1A shows the server 102 communicating with the kiosk computing device 108 through a network, other embodiments contemplate the server 102 communicating directly with the kiosk computing device 108 without the use of a separate and a distinct network. Additionally, other embodiments contemplate that the modules employed by the server 102 and the computing device 108 are integrated in one computing system. Further, the merchant computing system 122, the user account server 124, and the social network server 120 alternatively may communicate with the kiosk management server 102 via the network.

FIG. 1B depicts an example embodiment of a kiosk computing device 108 of the kiosk according to one aspect of the targeted advertising system 100. The kiosk computing device 108 is a computing or processing device that includes one or more processors 140 and memory 142 and is to receive data and/or communications from, and/or transmit data and/or communications to, the server 102 via the communication network 132. The kiosk computing device 108 includes an audio generation device 146, and a display 144, such as a computer monitor, for displaying targeted advertising content using a client application 152 stored in the memory 142. The client application 152 is executed on the processors 140 to play advertising content on the audio generation device 146 and/or the display 144. In one embodiment, the client application 148 incorporates a thin client model in which most or all of the functionality described herein for displaying advertising content and/or conducting financial transaction are performed by the application 104 and advertising content pushed to the kiosk computing device 108 for display thereby. In other embodiments, the client application 152 may be implemented as a thick client (e.g., fat client or heavy client) in which the functionality described herein for displaying advertising content and/or conducting financial transaction are performed at least partially by both the application 104 and the client application 152.

In one embodiment, the kiosk computing device 108 is a commercial off-the-shelf (COTS) computing device, such as a personal computer, a mobile computer, a tablet computer, a mobile device, and/or other computing device that is configured in or on the housing 102 using one or more mounting mechanisms, such as screws, bolts, hooks, zip ties, adhesives, track system, or other mechanism, such as one that maintains the computing device in or on the housing 102 using a tensioning mechanism. Such as COTS device includes a charging tether for providing power to the computing device, and/or a security or lasso tether to prevent its theft.

In another embodiment, the kiosk computing device 108 includes a custom design with the display 104, audio generation device 146, processors 140, and memory 142 individually integrated into the housing 102. For example, the display 104 and audio generation device 146 may be mounted on a surface of the housing 102 using a suitable attachment mechanism for providing advertising content to consumers. Example of such attachment mechanisms include, for example hinges and/or adhesives, such as weldment, hot glue, epoxy, and the like. Another example includes a housing 102 made of plastic that includes tabs integrally formed on the housing that hold the display 104 and audio generation device 146 in or on the housing 102 using a press-type fit. Yet another example includes tabs integrally formed on the housing 102 that are bent by the application of heat to secure the display 104, audio generation device 146, processors 140, and/or memory 142 to the housing 102.

In a particular embodiment, the kiosk computing device 108 is a tablet computer and the advertising content display application 148 is embodied as application software (i.e., an app) designed to be executed on the kiosk computing device 108. The operating software may be configured as a permissions-based format such that only the app is allowed to execute for administering the targeted advertising system 100. That is, consumers may be inhibited from executing any other application on the kiosk computing device 108. Additionally, the app may be locked (i.e., inhibited from executing) in response to detection of a tampering event and/or due to malfunction of the system. The kiosk management server 102 may also include administrator privileges (e.g. super user mode) that can be accessed via a unique key combination (e.g., password access) for servicing, maintaining, or otherwise administering the operation of the kiosk computing device 108.

The kiosk 110 may include any retail display support structure that supports and displays consumer items 112 for sale in a retail environment along with the kiosk computing device 108 for view by consumers. For example, the kiosk 110 may include a floor stand design that is supported by a floor, a counter-top design that is supported on a counter-top, and/or a wall-mount design that is hung and/or supported from a wall. Additional details related to generating advertising content to be displayed on the computing device, and facilitating transactions for consumer items associated with the advertising content are described in U.S. patent application Ser. No. 13/946,679, filed Jul. 19, 2013, and entitled “Stored Value Card Kiosk System and Method,” which is hereby incorporated herein by reference in its entirety.

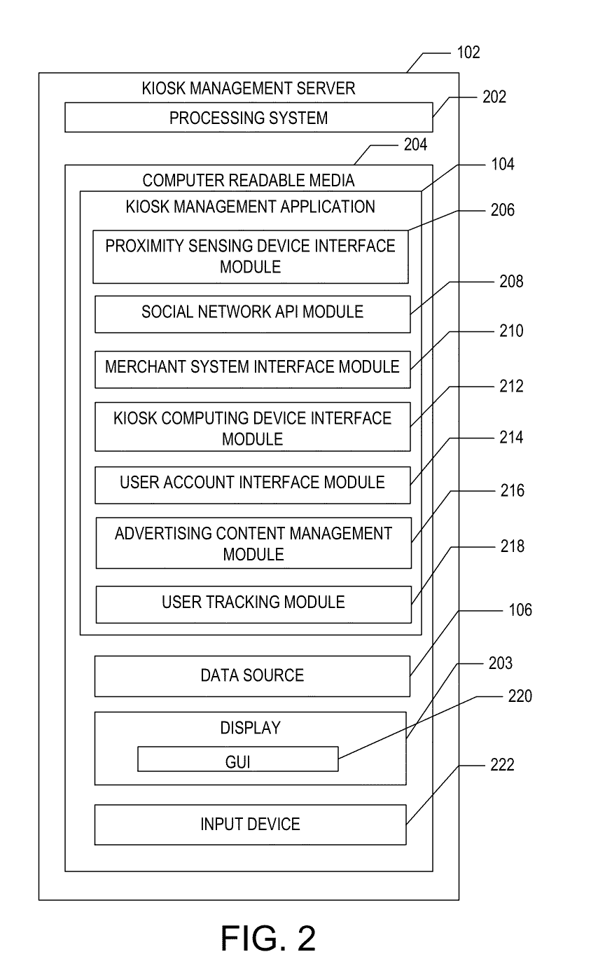

FIG. 2 is a block diagram depicting an example kiosk management application 104 executing on the kiosk management server 102. According to one embodiment, the kiosk management server 102 includes a processing system 202 that includes one or more processors or other processing devices. A processor is hardware. The processing system 202 executes the kiosk management application 104 to selectively transmit advertising content to the kiosk computing device 108, and control the manner in which the transmitted targeted advertising content is outputted (i.e., played) on the kiosk computing device 108. Additionally, the application 104 may receive the advertising content from one or more merchant computing systems 110 associated with one or more merchants that sponsor the stored value cards displayed in the kiosk 110.

According to one aspect, the kiosk management server 102 includes a computer readable media 204 on which the kiosk management application 104 and data source 106 are stored. The kiosk management application 104 includes instructions or modules that are executable by the processing system 202 to perform the features of the application 104 described herein.

The computer readable media 204 may include volatile media, nonvolatile media, removable media, non-removable media, and/or another available media that can be accessed by the kiosk management server 102. By way of example and not limitation, computer readable media 204 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system.

A proximity sensing device interface module 206 receives proximity information from a portable computing device 116 of a user and associates the proximity information with a particular user. For example, the proximity sensing device interface module 206 receives a message from the portable computing device 116 that includes proximity information associated with which proximity sensing device 114 triggered generation of the message. That is, the proximity information uniquely identifies which proximity sensing device prompted origination of the message. The message also includes user information that uniquely identifies which portable computing device 116 generated the message. In this manner, the proximity sensing device interface module 206 may be able to uniquely associate which user is in close proximity to the proximity sensing device.

In one embodiment, the proximity sensing device interface module 206 may be configured to interface with one or more proximity reporting systems administered by entities other than that administering the server 202. For example, the portable computing device 116 may be a smartphone or table computer on which a mobile application (e.g., mobile app) is installed that automatically generates a message which is subsequently transmitted to a remote computing system administered by an entity sponsoring the mobile app. In response, the computing system forwards the message to the proximity sensing device interface module 206 to indicate that the portable computing device 116 (i.e., and its user) are in close proximity to the kiosk 110. For this example, the mobile app may be sponsored by APPLE CORPORATION™ and the proximity sensing device 114 comprises an IBEACON™ based device. Nevertheless, it should be understood that any suitable type of proximity sensing and reporting system may be implemented without departing from the spirit and scope of the present disclosure.

A social network API module 208 provides an interface to one or more social network servers 120 to provide additional information about the user or a recipient of the consumer item 112 purchased by the user for the recipient. For example, the social network API module 208 accesses the API of a social media outlet to obtain personalized information associated with the user to generating targeting advertisements to be viewed by the user on the kiosk computing device 108. As another example, the social network API module 208 accesses the API of a social media outlet to obtain personalized information associated with one or more recipients to aid in selecting a consumer item 112 for purchase.

A merchant system interface module 210 facilitates the communication of advertising content and other information associated with the delivery and/or scheduling information associated with the advertising content to and from the merchant computing system 122. For example, the merchant system interface module 210 may receive an instance of advertising content along with scheduling instructions for how long and at what times of the day that the advertising content is to be played on the kiosk computing device 108. For another example, the merchant communication module 210 may facilitate the transmission of special offers or other incentives for purchasing play time from the server 102 to one or more of the merchant computing systems 122.

A kiosk computing device interface module 212 facilitates the communication of advertising content and other information associated with the delivery and/or scheduling information associated with the advertising content to the kiosk computing device 108. For example, the kiosk computing device communication module 212 may communicate with the advertising content display application 148 to transmit advertising content that is played on the display 144 and/or audio generation device 146.

In one embodiment, the kiosk computing device interface module 212 may communicate with the advertising content display application 152 to transmit advertising content that is played on the display 144 and/or audio generation device 146 directly without being initially stored in the memory 142 of the computing device. In this particular embodiment, the kiosk management server 104 may control at what time and with what frequency the advertising content is played on the kiosk computing device 108. In another embodiment, the computing device communication module 208 communicates with the advertising content display application 152 to transmit advertising content that is initially stored in the memory 142 of the kiosk computing device 108 along with instructions that may be used by the advertising content display application 152 for controlling at what time and with what frequency the advertising content is played on the kiosk computing device 108.

In one embodiment, the kiosk computing device interface module 212 facilitates the receipt of data and/or other communications from the kiosk computing device 108. That is, the user interface module 208 communicates with the kiosk computing device 108 to provide one or more selectable fields, editing screens, and the like for interacting with the user. For example, the kiosk computing device interface module 212 may use information known about the user to display a selectable menu list of friends of the user obtained from a social media website, such as FACEBOOK™, from which one may be selected by the user to be a recipient of a consumer item 112 purchased by the user. Additionally, the user interface module 212 may obtain analytics information known about the recipient to display one or more suggested consumer items 112 that the recipient may possibly like or enjoy.

In another embodiment, the kiosk computing device interface module 212 uses the GUI 220 of the server 102 to receive user input via the input device 222 to control the operation of the kiosk computing device 108. For example, an administrator may, from the display 203 and input device 222 of the server 102, control the kiosk computing device 108 to inhibit or allow certain functionality, perform periodic maintenance on the kiosk computing device 108, and/or access one or more log files associated with the operation of the kiosk computing device 108. The administrator, via the GUI 220, may manage advertising content that is displayed on the GUI 148 of the remote kiosk computing device 108. For example, the administrator may set a first advertising message of a first merchant to be displayed on the GUI 148 at set intervals (e.g., every 10 minutes), and set a second advertising message of a second merchant to be displayed on the GUI 148 at other set intervals (e.g., every 30 minutes) based upon any previously made financial agreements between the merchants and the administrator of the server 102.

A user account interface module 214 communicates one or more user account servers 120 associated with the user to generate additional targeted information to be displayed on the kiosk computing device 108. For example, the user account API module 214 may, upon obtaining knowledge of the unique identity of the user, obtain account information from a user account associated with the user from which advertising content may be generated and displayed on the kiosk computing device 108. In this example, the user account API module 214 may obtain information of a fuel saver account associated with the user to display targeted advertising content including special fuel saver offers or other incentives for enhancing use of the fuel saver account used by the user. As another example, the user account API module 214 may communicate with a payment processing server, such as a financial account server, to transact a monetary transfer of funds from the user's financial account to a financial account of a merchant of the consumer item 112. In one example, the user financial account API module 214 includes an application program interface (API) for coordinating a monetary transaction (e.g., online money transfer) through an e-commerce provider, such as PAYPAL™ online credit card systems, or other suitable third party financial clearing entity.

An advertising content management module 216 manages the play (i.e., output) of advertising content on the display 144 of the kiosk computing device 108. The advertising content management module 216 controls what advertising content is played, at what times the advertising content is played, and/or with what frequency the advertising content is played on the kiosk computing device 108. For example, the advertising management module 216 may schedule additional play time for advertising content associated with recreational merchants by a kiosk located in a vacation region, while scheduling additional play time for advertising content associated with sporting paraphernalia by a kiosk 108 located near a sports stadium, or other sporting venue.

A user tracking module 218 maintains a historical record of proximity detection events and/or consumer items 112 purchased by the user which is stored in the user tracking files 136. For example, the proximity detection events may include records of what proximity sensing devices 114, and how often these proximity detection events occurred for each portable computing device 116. As another example, the user tracking module 218 may include information associated with what types of consumer items 112 were purchased by the user and how many of these consumer items 112 were purchased by the user. The user tracking module 218 may perform analytics on this information to derive any behavioral patterns of the user from which to generate targeted advertising for that user.

The user tracking module 218 may periodically processes this information to generate reports for the retailer who administers the system 100. These reports may be compared with the played advertising content to assess an advertising effectiveness level of the advertising content that is played on the kiosk computing device 108. In one embodiment, the user tracking module 218 modifies the advertising content along with the time of day and the playing frequency of the advertising content according to the historical purchase information included in the reports.

The user tracking module 218 monitors transactions conducted through the use of the kiosk 108 by storing the transactions in the historical purchase information 132. For example, the user tracking module 218 may periodically report (or report upon demand) usage information associated with the kiosk 108. This usage information may include, for example, which type of stored value cards are most often activated and a distribution of how much money is activated on these cards. Information such as this may be useful for distribution to merchants that sell the consumer items 112 to solicit their further use of the system 100.

It should be appreciated that the modules described herein are provided only as an example of a computing device that may execute the kiosk management application 104 according to the teachings of the present invention, and that other computing devices may have the same modules, different modules, additional modules, or fewer modules than those described herein. For example, one or more modules as described in FIG. 2 may be combined into a single module. As another example, certain modules described herein may be encoded and executed on other computing devices, such as the kiosk computing device 108 used by the user. Further, one or more or all of the modules may be stored and executed by the kiosk management server 102 and data and instructions are transmitted to and from the kiosk management server 102 and the kiosk computing device 108 to execute their functions. As yet another example, the consumer item management application 104 may, or may not have a merchant communication module 206 based upon whether automated content scheduling by the merchants sponsoring the advertising content is needed or desired. Additionally, the consumer item management application 104 may, or may not have an auditing and tracking module 212 based upon whether tracking of historical purchase information associated with the stored value cards is needed or desired.

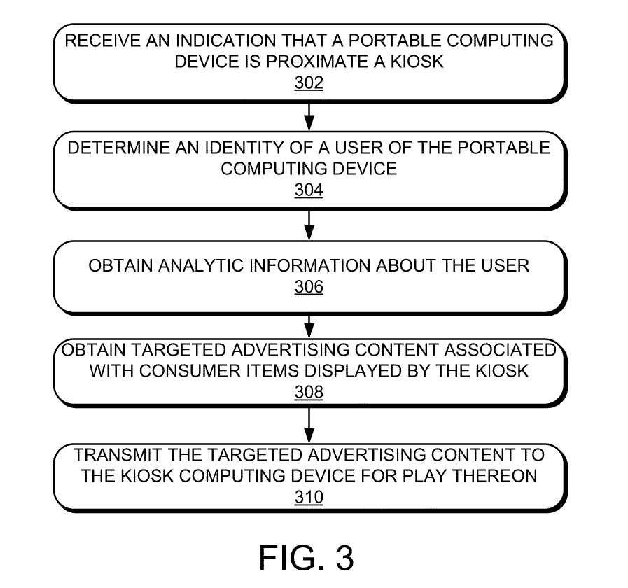

FIG. 3 illustrates an example process that may be performed by the kiosk management application 104 according to the teachings of the present disclosure.

In step 302, the application 104 determines when a portable computing device is proximate a kiosk 110. The portable computing device 116 may include any type of device that functions with a proximity sensing device configured on the kiosk.

For example, the proximity sensing device 114 may be configured to utilize radio frequency (RF) signals, optical signals (e.g., infrared radiation), magnetic energy, and/or acoustic signals (e.g., ultrasonic energy) that may be detected or generated by the portable computing device 116. In a particular example, the proximity sensing device comprises an indoor positioning system (IPS) that wirelessly detects objects, such as portable computing device 116 handled, worn, and/or carried by their users.

In step 304, the application 104 determines an identity of a user of the portable computing device 116. For example, the portable computing device 116 may include a mobile app that functions with an IBEACON™ device that when moved within range thereof, causes the portable computing device 116 to generate a message including information associated with the location of the IBEACON™ device and an identity of the portable computing device 116. The message may either be transmitted directly to the server 202 or to a third party server of an entity administering operation of the proximity sensing device, which subsequently forwards the message to the server 202. Using the identity of the portable computing device 116, the third party server or server 202 determines the user that is associated with the portable computing device 116. Other technologies may be used. For example, the proximity sensing device 114 may include a radio frequency identification (RFID) device that receives radio frequency interrogation messages and emits RF signals in response to the interrogation messages in which the RF signals include identification information associated with the RFID device.

In step 306, the application 104 obtains analytic information about the user. The application 104 may derive the analytic information itself using information known about the identity of the user, and/or may obtain the analytic information from a third party source, such as GOOGLE ANALYTICS™ that data mines information about users of their products and services. In one embodiment, the application 104 derives analytic information using multiple proximity detection events generated by the portable computing device 116 over a period of time, and/or from historical purchase information of consumer items purchased via the system. For example, the application 104 may communicate with multiple kiosks 110 placed at various locations around a retail establishment to determine the shopping behaviors of a user over a period of several months. Given this time frame, the application 104 may generate a behavioral profile that may be used by the application 104 for generating targeted advertising for that user.

In step 308, the application 104 obtains targeted advertising content associated with consumer items displayed by kiosk according to the derived analytic information. The targeted advertising content may include any suitable type of content that may be displayed or otherwise played on the kiosk computing system 108, such as textual, audio, images, photographs, and/or video content. For example, the advertising content may include information, such as special offers associated with the stored value cards, generic advertisements to generate enhanced consumer awareness of the merchant sponsoring the stored value card, information about how the stored value card may be redeemed by the recipient, information about particular retail products that may be purchased using the stored value card, and the like.

The application 104 may generate the targeted advertising content, and/or may obtain the targeted advertising content from a third party source. From the example described above in which analytic information is derived from multiple proximity detection events over a period of time, the application 104 may generate targeted advertising content related to a likelihood that the user may be interested in purchasing a particular consumer item 112 displayed on the kiosk 110. The application 104 may also obtain the targeted advertising content from a third party source. For example, the application 104 may transmit the analytic information to a third party source, such as a manufacturer of a consumer item 112 displayed on the kiosk 110, that generates the targeted advertising content which is subsequently transmitted to the application 104 and then forwarded to the kiosk computing device 108 for display thereon.

In step 310, the application 104 transmits the targeted advertising content to the kiosk computing device 108 for display thereon. The targeted advertising content may include, for example, textual content, photographic content, audio content, as well as video content. In one embodiment, the targeted advertising content may include an interactive display that allows the user to input information for further tailoring of the content displayed for the user. For example, if the user is considering purchase of a consumer item 112 as a gift for a recipient, the application 104 may obtain friend information from a social media server 120, such as FACEBOOK™ and display a list of the user's friends for selection by the user. As another example, the application 104 may display multiple categories of consumer items 112 that may be selected by the user for obtaining additional information about the types and nature of consumer items 112 offered for sale on the kiosk 110.

The process described above continues throughout operation of the kiosk management system 100. However, when use of the stored value card management system 100 is no longer needed or desired the process ends.

Those skilled in the art will appreciate that variations from the specific embodiments disclosed above are contemplated by the invention. The invention should not be restricted to the above embodiments, but should be measured by the following claims.

What is claimed is:

1. A retail display unit comprising:
a retail display structure to support and display one or more consumer items for sale;
a retailer computing device supported in the retail display structure and comprising a display, one or more processors, and one or more memory units to store an application that is executed by the one or more processors to display advertising content on the display, and conduct a financial transaction for at least one of the consumer items;
a proximity sensing device configured in the retail display structure and coupled to the retailer computing device,
wherein the application is executed to:
determine, using the proximity sensing device, when a portable computing device is within a specified range from the retail display structure;
obtain advertising content associated with the consumer items, the advertising content generated according to analytic information associated with a user of the portable computing device; and
display the advertising content on the display for view by the user of the portable computing device.

2. The retail display unit of claim 1, wherein the application determines when a portable computing device is within the specified range by:
controlling the proximity sensing device to emit periodic signals with a specified power level such that when the portable computing device detects the signals, the portable computing device transmits analytic information associated with a user of the wireless device to a central advertising server; and
receiving the advertising content from a server, the advertising content generated according to the received analytic information and the consumer items for sale, and transmitting the advertising content to the retailer computing device.

3. The retail display unit of claim 2, wherein the server is configured to generate the advertising content according to an advertising effectiveness level of at least one instance of the advertisement content associated with one of the consumer items.

4. The retail display unit of claim 1, wherein the proximity sensing system comprises at least one of an indoor proximity system (IPS) device and a near field communication device.

5. The retail display unit of claim 1, wherein the application is further executed to display one or more interactive fields for receiving recipient information associated with an intended recipient of the at least one consumer item, wherein the recipient is separate and distinct from the user.

6. The retail display unit of claim 5, wherein the application is further executed to generate the analytic information from the recipient information.

7. The retail display unit of claim 1, wherein the advertising content comprises information associated with an account of the user, the account being managed by a merchant of the user.

8. The retail display unit of claim 7, wherein the account comprises at least one of a financial account associated with the user, a loyalty card program associated with the merchant, and a prepaid phone account associated with the user.

9. The retail display unit of claim 1, wherein the one or more consumer items comprises one or more stored value cards available for purchase by the user.

10. An advertising method comprising:
providing a retailer computing device and a proximity sensing device configured in a retail display structure that supports and displays one or more consumer items for sale,
displaying, by at least one processor executing instructions stored in at least one memory unit, advertising content on the display and conduct a financial transaction for at least one of the consumer items;
determining, by the at least one processor, when a portable computing device is within a specified range from the retail display structure using the proximity sensing device;
obtaining, by the at least one processor, advertising content associated with the consumer items, the advertising content generated according to analytic information associated with a user of the portable computing device; and
displaying, by the at least one processor, the advertising content on the display for view by the user of the portable computing device.

11. The advertising method of claim 10, further comprising:
determining when the portable computing device is within the specified range by:
controlling the proximity sensing device to emit periodic signals with a specified power level;
transmitting analytic information associated with a user of the wireless device to a central advertising server when the portable computing device detects the signals;
generating the advertising content according to the received analytic information and the consumer items for sale; and
transmitting the advertising content to the retailer computing device.

12. The advertising method of claim 11, further comprising generating the advertising content according to an advertising effectiveness level of one instance of the advertisement content associated with one of the consumer items.

13. The advertising method of claim 10, further comprising displaying one or more interactive fields for receiving recipient information associated with an intended recipient of the at least one consumer item, wherein the recipient is separate and distinct from the user.

14. The advertising method of claim 13, further comprising generating the analytic information from the recipient information.

15. The advertising method of claim 10, wherein the advertising content comprises information associated with an account of the user, the account being managed by a merchant of the user.

16. The advertising method of claim 15, wherein the account comprises at least one of a financial account associated with the user, a loyalty card program associated with the user, and a prepaid phone account associated with the user.

17. A retail kiosk advertising system comprising:
a retail display structure to support and display one or more consumer items for sale and a display of a retailer computing device; and
a retail display structure management server comprising at least one memory for storing an application that when executed by at least one processor, is executed to:
receive proximity information from a proximity sensing device configured on the retail display structure, the proximity information indicating when a portable computing device is within a specified range of the retail display structure;
determine an identity of a user of the portable computing device from the received proximity information;
obtain targeted advertising content associated with the consumer items, the advertising content generated according to analytic information associated with the identified user of the portable computing device;
transmit the targeted advertising content to the retailer computing device, wherein the retailer computing device plays the targeted advertising for view by the user; and
facilitate a transaction for the consumer item with the user.

18. The retail kiosk advertising system of claim 17, wherein the application is further executed to obtain the targeted advertising content from a social media server.

19. The retail kiosk advertising system of claim 17, wherein the application is further executed to derive the targeted advertising content from information stored in the retail display structure management server.

20. The retail kiosk advertising system of claim 19, wherein the central advertising server is configured to generate the advertising content according to an advertising effectiveness level of at least one instance of the advertisement content associated with one of the consumer items.

21. The retail kiosk advertising system of claim 17, wherein the application is further executed to display one or more interactive fields for receiving recipient information associated with an intended recipient of the at least one consumer item, wherein the recipient is separate and distinct from the user.
